(19) United States
(12) Patent Application Publication
(10) Pub. No.: US 2010/0002448 A1
(43) Pub. Date: Jan. 7, 2010

(54) STREET LAMP WITH IMPROVED EMISSION EFFICIENCY

(75) Inventor: Ming-Jhih Shih, Tainan (TW)

Correspondence Address: WPAT, PC;INTELLECTUAL PROPERTY ATTORNEYS, 2030 MAIN STREET, SUITE 1300, IRVINE, CA, 92614, US

(73) Assignee: TYC BROTHER INDUSTRIAL CO., LTD., Tainan (TW)

(21) Appl. No.: 12/479,413

(22) Filed: Jun. 5, 2009

(30) Foreign Application Priority Data
Jul. 2, 2008 (TW) 097211737

(51) Int. Cl. F21V 7/07

(52) U.S. Cl. 362/296.05; 362/296.09

(57) ABSTRACT

The invention relates to a street lamp with improved emission efficiency. The street lamp of the invention includes: a base, a transparent plate, a projecting mirror and a cover. The transparent plate is mounted on an aperture of the base. The projecting mirror is formed as a concave and arc mask with a waved shape, and has a reflecting surface and a lamp holder. The reflecting surface is mounted on the inner concave side and has a plurality of reflecting sections. The lamp holder is mounted on a side wall of the projecting mirror and is used for mounting a lamp. The cover combines with the base. By using a metal halide lamp with low power consumption and high luminous intensity, and having a reflecting surface that has a precise optical design and average light distribution, the street lamp of the invention can reduce power consumption, improve emission and multi-reflection efficiencies, and increase the average luminous intensity and the entire luminous effect.

### BACKGROUND OF THE INVENTION

1. Field of the Invention

The present invention relates to a street lamp, more particularly, a street lamp with improved emission efficiency.

2. Description of the Related Art

Street lamps are important and necessary emission devices specially when it is dark at night. Taiwan Patent Gazette No. 228287 and entitled “Improved Structure of Street Lamps” talked about the structure of a conventional street lamp. A conventional street lamp includes a base, a transparent plate, a reflecting cover and an upper cover. The base has a fixing portion and an aperture. The fixing portion is used for receiving a light rod, and the aperture is displaced on the bottom of the base. The transparent plate is mounted on the aperture. The reflecting cover is formed as a concave and arc mask in aluminum, and has a lamp holder. The lamp holder is mounted on an end of the reflecting cover towards the fixing portion, and is used for mounting a lamp. The upper cover has a pivot structure and a clamp. The pivot structure is used for combining with the base, and the clamp is used for fixing on the base.

The light from the lamp is partially emitted through the transparent plate directly and downwardly, and the partial light is emitted to the reflecting cover and is then reflected downwardly.

However, a conventional street lamp has the following problems and defects:

1. high power consumption and low color rendering, and low environmental friendliness: A conventional street lamp generally uses a mercury light bulb or high pressure sodium-vapor light bulb to produce light. For a mercury light bulb, the power consumption is about 250 watts at a luminous intensity of 1500 lumen (lm), which is relatively high. In addition, as mercury bulbs contain mercury and so they do not meet the statutory requirements for environmental protection. As for a high pressure sodium-vapor light bulb, it can produce a luminous intensity of 120 lm/w at 400 watts only. Furthermore, the color of the light is close to the color yellow, thus lowering the color rendering. Hence, if an object is placed under a high pressure sodium-vapor street lamp, the true color of the object cannot be correctly shown. For example, policemen will not be able to tell the exact colors of the images shown on their devices if they stand under a high pressure sodium-vapor street lamp.

2. low reflection efficiency and low emission efficiency: The reflecting cover of a conventional street lamp is made of aluminum by punching, and the surface of the aluminum material is rough and the inside of the reflecting cover cannot disseminate any light because it is not optically designed. This may result in low reflectance. A test shows that the reflectance of the reflecting cover of the conventional street lamp is about 0.5, and the emission efficiency of the lamp is reduced.

Based on the above, it is necessary to provide a street lamp that does not have the above problems.

### SUMMARY OF THE INVENTION

The present invention is a street lamp with improved emission efficiency. The street lamp of the invention includes a base, a transparent plate, a projecting mirror and a cover. The base has a fixing portion, an aperture and a plurality of pillars. The fixing portion is used for receiving a light rod, and the pillars are mounted around the aperture. The transparent plate is mounted on the aperture. The projecting mirror is formed as a concave and arc mask with a waved shape, and has a plurality of extending portions, a reflecting surface and a lamp holder. The extending portions are corresponding to the pillars and are used for fixing on the pillars. The reflecting surface is mounted on the inner concave side and has a plurality of reflecting sections. The lamp holder is mounted on a sidewall of the projecting mirror and is used for mounting a lamp. The cover has a pivot structure and a clamp. The pivot structure is used for combining with the base, and the clamp is used for fixing on the base.

According to the invention, the reflecting surface has gone through a vacuum surface treatment, and the light bulb is a metal halide light bulb. By using a metal halide light bulb that has low power consumption and high luminous intensity, and a reflecting surface of a precise optical design and average light distribution, the street lamp of the present invention can reduce power consumption, improve emission and multi-reflection efficiencies, and increase the average luminous intensity and the entire luminous effect.

### BRIEF DESCRIPTION OF THE DRAWINGS

FIG. 1 shows an exploded perspective view of the street lamp according to a first embodiment of the invention.

FIG. 2 shows a bottom view of the projecting mirror from a first angle according to the first embodiment of the invention.

FIG. 3 shows a bottom view of the projecting mirror from a second angle according to the first embodiment of the invention.

FIG. 4 shows a combined cross-sectional view according to the first embodiment of the invention.

FIG. 5 shows a bottom view of the projecting mirror from a first angle according to the second embodiment of the invention.

FIG. 6 shows a bottom view of the projecting mirror from a second angle according to the second embodiment of the invention.

FIG. 7 shows a bottom view of the projecting mirror according to a third embodiment of the invention.

FIG. 8 shows a bottom view of the projecting mirror according to a fourth embodiment of the invention.

FIG. 9 shows a bottom view of the projecting mirror with the lamp according to the second embodiment of the invention.

### DETAILED DESCRIPTION OF THE INVENTION

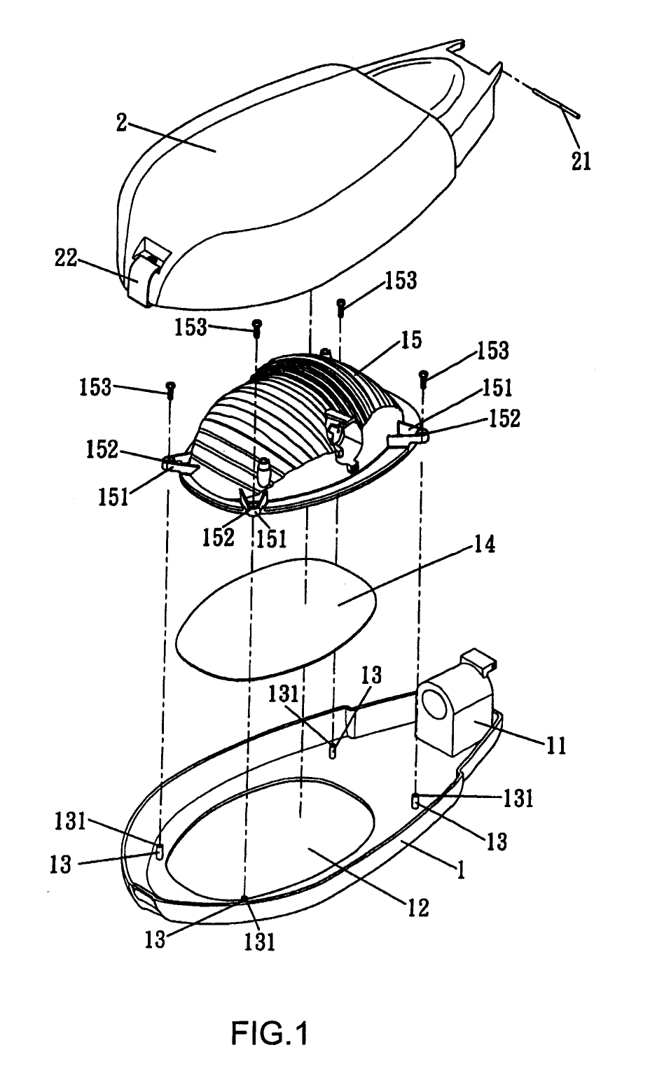

FIG. 1 shows an exploded perspective view of the street lamp according to a first embodiment of the invention. The street lamp of the invention includes: a base 1, a transparent plate 14, a projecting mirror 15 and a cover 2. The base 1 has a fixing portion 11, an aperture 12 and a plurality of pillars 13. The fixing portion 11 is used for receiving a light rod (not shown), and the pillars 13 are mounted around the aperture 12. In the embodiment, each of the pillars 13 has a receiving hole 131 formed on the top of the pillar.

The transparent plate 14 is mounted on the aperture 12. The projecting mirror 15 is mounted above the transparent plate 14, and is formed as a concave and arc mask with a waved shape, and has a plurality of extending portions 151, a reflecting surface 154 and a lamp holder 155. The extending portions 151 are corresponding to the pillars 13, and are used for fixing on each of the pillars 13. In the embodiment, each of the extending portions 151 has a through hole 152 for receiving a fixing element 153 to be fixed into the receiving hole 131 of the pillars 13.

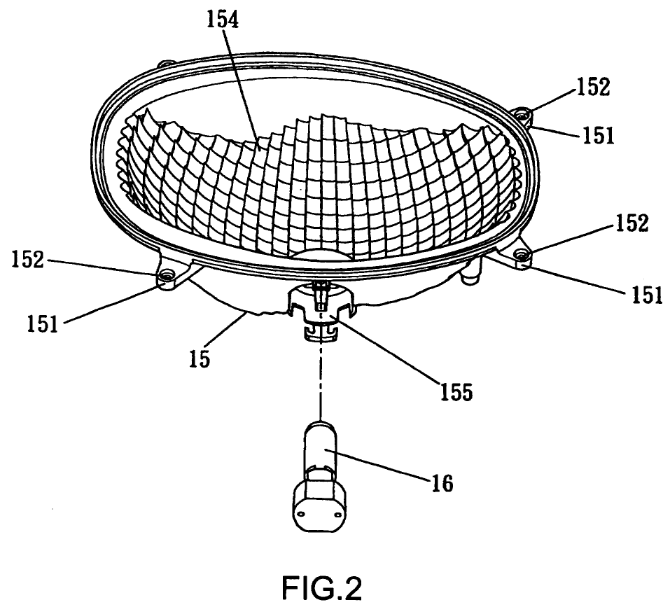

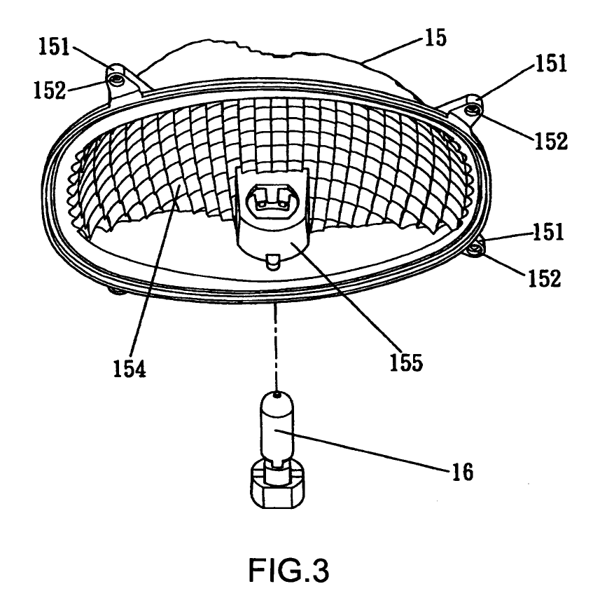

According to FIG. 2 and FIG. 3, the reflecting surface 154 is mounted on the inner concave side of the projecting mirror 15, and has a plurality of reflecting sections. In the embodiment, the reflecting surface 154 has undergone a vacuum surface treatment, that is, vacuum plating, and the reflecting surface 154 is an optical surface. Therefore, the reflecting surface 154 has the best reflection efficiency. A test shows that the reflectance of the reflecting surface 154 is about 0.8. Furthermore, two sides of the reflecting surface 154 are plane sidewalls.

The lamp holder 155 is mounted on a sidewall of the projecting mirror 15 and is used for mounting a lamp 16. In the first embodiment, the lamp holder 155 is mounted on a first sidewall of the projecting mirror 15, and the first sidewall is on a short axle direction of the projecting mirror 15. In the embodiment, the lamp 16 is a metal halide lamp with a luminous intensity of 15500 lumen (lm), a power consumption of 150 watts and a color rendering of 90.

The cover 2 has a pivot structure and a clamp. The pivot structure is used for combining with the base 1, and the clamp 22 is used for fixing on the base 1. In the embodiment, the pivot structure includes a pin 21 for combining with the base 1 so that the cover 2 can be opened or closed corresponding to the base 1.

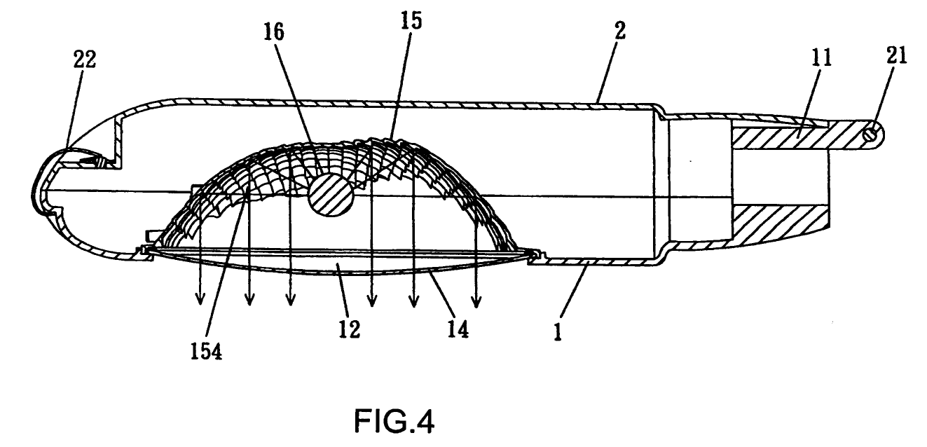

FIG. 4 shows a combined cross-sectional view according to the first embodiment of the invention. First, the metal halide lamp 16 is fixed on the lamp holder 155 of the projecting mirror 15; the projecting mirror 15 with the metal halide lamp 16 is then mounted on the transparent plate 14. The fixing element 153 is used for fixing into the receiving hole 131 of the pillar 13 through the through hole 152 of the extending portion 151 so as to fix the projecting mirror 15 on the base 1. The cover 2 is closed on the base 1, and the clamp 22 is used to combine the base 1 and the cover 2. When the metal halide lamp 16 produces light, the light so produced is be emitted downwardly through the transparent plate 14, and the partial light is emitted to the projecting mirror 15 and then reflected downwardly by the reflecting sections of the reflecting surface so as to form uniform light.

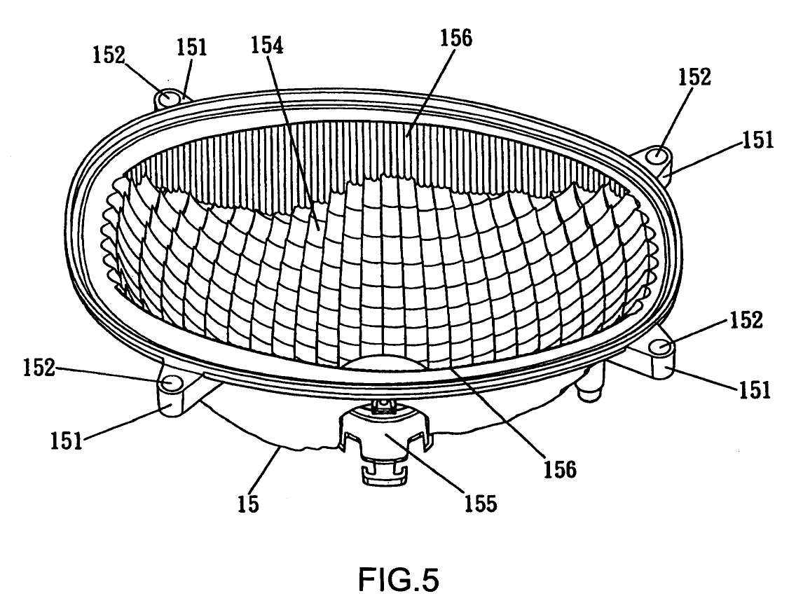

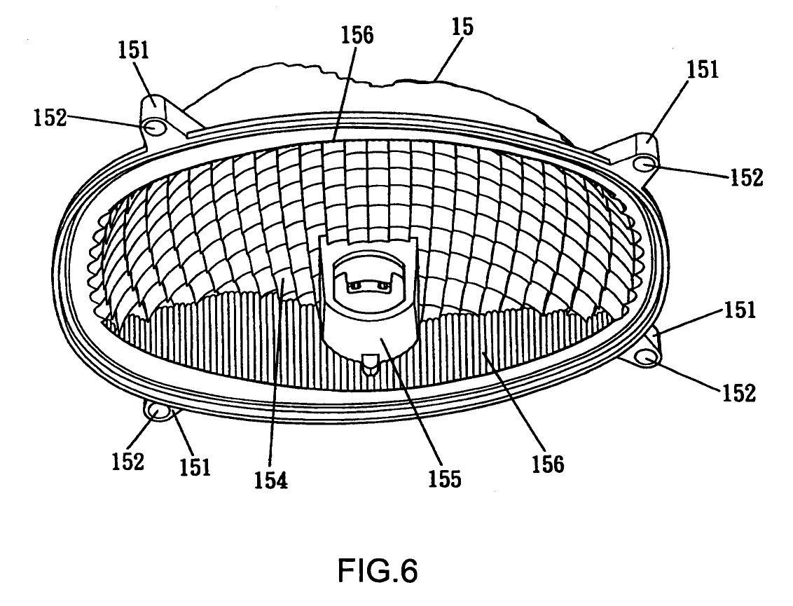

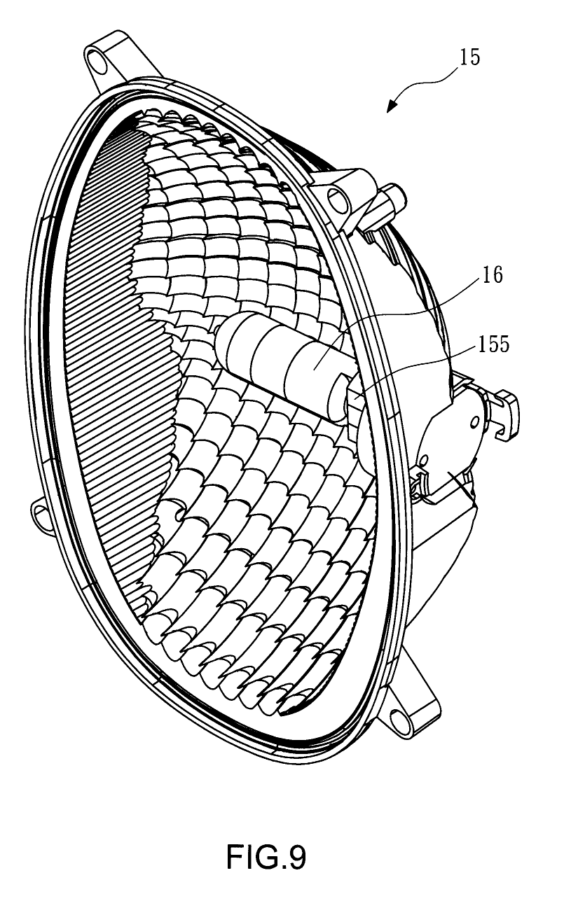

For FIG. 5 and FIG. 6, they show the bottom views of the invention according to a second embodiment of the invention. In the embodiment, the projecting mirror 15 further includes a plurality of stripe reflecting sections 156 with a waved shape mounted on two sides of the reflecting surface 154. The stripe reflecting sections 156 are used for reflecting the light so as to avoid the glare and improve the uniformity of the light. In the second embodiment, the lamp holder 155 is mounted on a first sidewall of the projecting mirror 15, and the first sidewall is on a short axle direction of the projecting mirror 15. The lamp 16 is mounted on the lamp holder 155 as shown in FIG. 9.

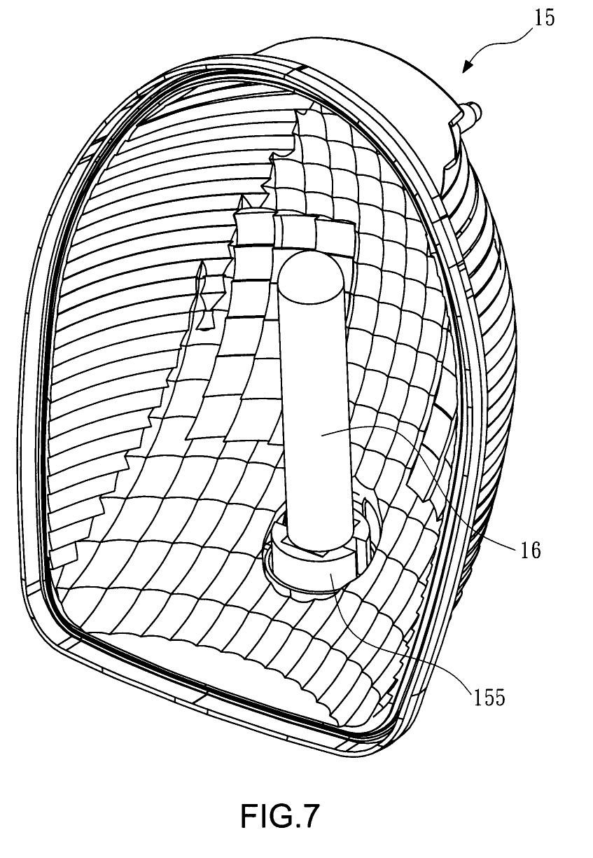

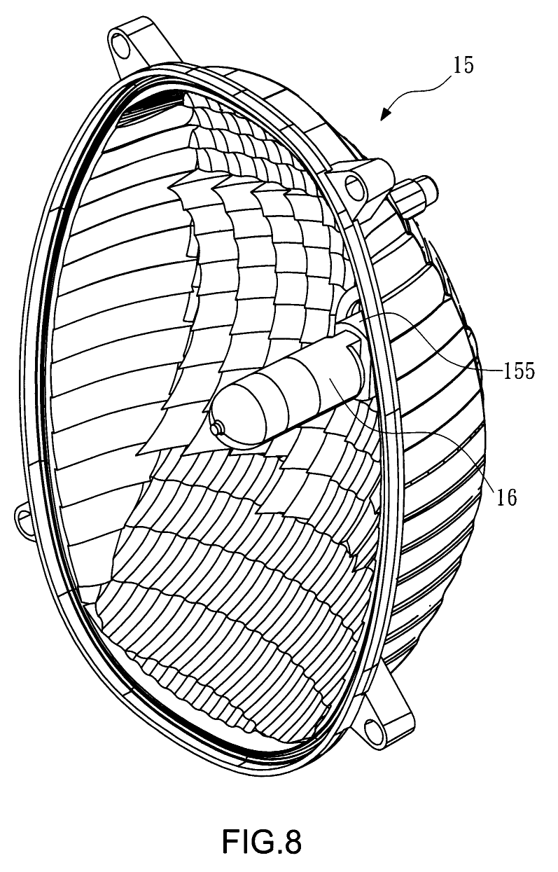

FIG. 7 shows a bottom view of the projecting mirror according to a third embodiment of the invention. In the third embodiment, the lamp holder 155 is mounted on a second sidewall of the projecting mirror 15, and the second sidewall is on a long axle direction of the projecting mirror 15. FIG. 8 shows a bottom view of the projecting mirror according to a fourth embodiment of the invention. In the fourth embodiment, the lamp holder 155 is mounted on a third sidewall of the projecting mirror 15, and the third sidewall is on a middle portion of the projecting mirror 15.

Given the above, the present invention has the following advantages and effects:

1. low power consumption: Because the invention uses the metal halide lamp 16 to produce light, the power consumption is about 150 watts with a luminous intensity of 90-100 lm/w. It thus meets the statutory requirement (the average luminous intensity 20 lux). Compared to mercury lamps and high pressure sodium-vapor lamps, the street lamp of the invention consumes less power and the saving power efficiency is about 62%. Furthermore, the street lamp of the present invention meets the requirement for environmental protection.

2. better color rendering and realistic colors: Because the color rendering of the metal halide lamp 16 of the invention is higher than that of high pressure sodium-vapor lamps, the actual colors of the objects under the street lamp of the invention can be better reflected than under a conventional street lamp. When policemen watch the screen of their devices under the street lamp of the invention, they can clearly see the images shown thereon.

3. improved emission efficiency: Because the reflecting surface 154 has a plurality of reflecting sections (multi-reflectors) and has undergone a vacuum surface treatment, the reflecting efficiency and the optical efficiency of the reflecting surface 154 can be improved greatly. A test shows that the reflectance of the reflecting surface 154 is about 0.8, and the optical efficiency is about 60%. Furthermore, the reflecting surface 154 of the invention is made with a precise optical design, and can raise the average and uniformity of the luminous intensity when distributing the light. A test using the present invention along the roadside shows that the average luminous intensity can be above 20 lm.

While several embodiments of the present invention have been illustrated and described, various modifications and improvements can be made by those skilled in the art. The embodiments of the present invention are therefore described in an illustrative, but not restrictive, sense. It is intended that the present invention may not be limited to the illustrated forms, and that all modifications that maintain the spirit and scope of the present invention are within the scope defined in the appended claims.

What is claimed is:

1. A street lamp with improved emission efficiency, comprising:
a base, having a fixing portion, an aperture and a plurality of pillars, the fixing portion for receiving a light rod, and the pillars mounted around the aperture;
a transparent plate, mounted on the aperture;
a projecting mirror, formed as a concave and arc mask with a waved shape, and having a plurality of extending portions, a reflecting surface and a lamp holder, the extending portions corresponding to the pillars and for fixing on the pillars, the reflecting surface mounted on the inner concave side and having a plurality of reflecting sections, the lamp holder mounted on a sidewall of the projecting mirror and for mounting a lamp; and
a cover, having a pivot structure and a clamp, the pivot structure for combining with the base, the clamp for fixing on the base.

2. The street lamp according to claim 1, wherein the reflecting surface has undergone a vacuum surface treatment.

3. The street lamp according to claim 1, further comprising a plurality of stripe reflecting sections with a waved shape mounted on two sides of the reflecting surface.

4. The street lamp according to claim 3, wherein the reflecting surface has undergone a vacuum surface treatment.

5. The street lamp according to claim 1, wherein the lamp is a metal halide lamp.

6. The street lamp according to claim 1, wherein two sides of the reflecting surface are plane sidewalls.

7. The street lamp according to claim 1, wherein the lamp holder is mounted on a first sidewall of the projecting mirror, and the first sidewall is on a short axle direction of the projecting mirror.

8. The street lamp according to claim 1, wherein the lamp holder is mounted on a second sidewall of the projecting mirror, and the second sidewall is on a long axle direction of the projecting mirror.

9. The street lamp according to claim 1, wherein the lamp holder is mounted on a third sidewall of the projecting mirror, and the third sidewall is on a middle portion of the projecting mirror.
